(19) United States
(12) Patent Application Publication
(10) Pub. No.: US 2007/0059231 A1
(43) Pub. Date: Mar. 15, 2007

(54) Methods for producing ammonium pentaborate from alkaline earth tetraboartes that dramiatically reduces the amount of residual ammonia

(76) Inventor: Thomas L. Bosserman, Fort Wayne, IN (US)

Correspondence Address: Thomas L. Bosserman, 15430 Coldwater Road, Fort Wayne, IN, 46845, US

(21) Appl. No.: 11/518,623

(22) Filed: Sep. 11, 2006

Related U.S. Application Data
(60) Provisional application No. 60/716,998, filed on Sep. 15, 2005.

(51) Int. Cl. C01B 35/12

(52) U.S. Cl. 423/277

(57) ABSTRACT

This invention describes methods for the preparation of aqueous solutions of ammonium pentaborate by reacting alkaline earth tetraborates in water with selected mineral acids followed by the addition of ammonia or ammonium hydroxide. These methods dramatically reduces the amount of residual ammonia as compared to earlier teachings that depended on the use of the di-ammonium salts of mineral acids. The resultant solutions contain by design little or no residual ammonia making the compositions compatible with binding resins used in the manufacture of wood composites. The so prepared solutions can be used to treat wood and wood products, as well as wood particles, chips or strands and wood laminates imparting the properties of fire retardancy and resistance to attack by wood eating and or destroying insects.

### PATENT REFERENCES

1. United Kingdom No. 10361 Issued 1897

2. U.S. Pat. No. 2,102,126 Method for Producing Ammonia and Boric Acid, Peterson, 1937

3. U.S. Pat. No. 4,196,177 Process for Producing Boron Compounds from Borate Ores, Sallay, 1980

4. U.S. Pat. No. 4,382,025 Ammonium Triborate, A new Flame Retardant, Sallay, 1983

5. U.S. Pat. No. 4,509,546 Method for Flame Retarding Materials, Sallay 1985

6. U.S. Pat. No. 4,514,326 Permanent Flame Retardant and Anti-smoldering Compound, Sallay, 1985

7. U.S. Pat. No. 4,873,084 Insecticidal Compounds, Sallay, 1989

### BACKGROUND OF THE INVENTION

Several US patents have been issued for the preparation of ammonium pentaborate from alkaline earth tetraborates. An early British patent (no. 10,361) issued in 1897 teaches that in a reaction between an alkaline earth tetraborate and the ammonium salt of a mineral acid, one of the final products is ammonium tetraborate. A US patent issued in 1937 to Peterson (U.S. Pat. No. 2,102,126) taught that the reaction between sodium tetraborate and ammonium sulfate produced sodium sulfate, boric acid, and ammonia. However, Sallay in his studies was able to demonstrate that the teachings of the aforementioned patents were incorrect and that the products of the reactions cited above are sodium sulfate, ammonium pentaborate and residual ammonia. He was able to demonstrate that ammonium tetraborate is formed as an interim product, transforming into ammonium pentaborate in contact with water, releasing ammonia.

Sallay has taught a continuing art in the process of obtaining ammonium pentaborate from alkaline earth tetraborates. The teachings have been progressive, but the same chemistry of equi-molar reactions between sodium tetraborate and di-ammonium salts of selected mineral acids have been described in his various patents.

The first three patents issued by Sallay all describe the art of producing ammonium pentaborate from alkaline earth tetraborates by reactions with sulfur dioxide, and anhydrous ammonia using methanol as the solvent. His first patent entitled Process for Producing Boron Compounds from Borate Ores (U.S. Pat. No. 4,196,177), issued on Apr. 1, 1980 teaches the art of reacting sodium tetraborate with sulfur dioxide gas and anhydrous ammonia with methanol as the solvent. Sodium sulfite, the by-product of this method, is insoluble in methanol and is easily removed by filtration. The transitory compound ammonium triborate was isolated in the methanolic filtrate.

His next patent issued on May 3, 1983 entitled Ammonium Triborate, A new Flame Retardant (U.S. Pat. No. 4,382,025) teaches that when exposed to water in either liquid or vapor form, the compound ammonium triborate spontaneously transforms into ammonium pentaborate.

Sallay continued with this process in yet another patent (U.S. Pat. No. 4,509,546) issued on Mar. 12, 1985. In this patent entitled Method for Flame Retarding Material with Ammonium Triborate, Sallay teaches the chemistry that with methanol as the solvent, ammonium tetraborate is initially formed, which then transforms to the compound ammonium triborate which in contact with water, transforms to ammonium pentaborate with the release of excess ammonia.

Sallay then continued with another patent entitled Permanent Flame Retardant and Anti-smoldering Compound (U.S. Pat. No. 4,514,326), issued on Apr. 30, 1985. Sallay teaches a method of producing ammonium pentaborate in water, not methanol as in previous patents. In this patent he teaches the art of using equi-molar amounts of ammonium sulfate, or sulfite, or di-ammonium hydrogen phosphate with sodium tetraborate in water to produce ammonium pentaborate and the corresponding sodium salt, as sodium sulfite, sulfate, or di-sodium hydrogen phosphate. Sallay teaches that ammonium sulfate, sulfite or di-ammonium hydrogen phosphate is required in the reaction with alkaline earth tetraborates to produce the interim product of ammonium tetraborate, which in the presence of water transforms to ammonium pentaborate with a release of excess ammonia.
1. (NH₄)₂B₄O₇.4H₂O+H₂O→0.8NH₄B₅O₈.4H₂O+1.2NH₄OH+2.2H₂O
The teaching of producing ammonium pentaborate in water with equi-molar amounts of ammonium sulfate and sodium tetraborate can be best described as follows;
2.a. Na₂B₄O₇.5H₂O+(NH₄)₂SO₄+water→(NH₄)₂B₄O₇.4H₂O+Na₂SO₄
b. (NH₄)₂B₄O₇.4H₂O+water+Na₂SO₄→0.8NH₄B₅O₈.4H₂O+Na₂SO₄+1.2NH₄OH
The art of using one mole of ammonium sulfate, sulfite, or di-ammonium hydrogen phosphate when reacted in water with one mole of sodium tetraborate produces as reaction products, one mole of sodium sulfate, sulfite, or di-sodium hydrogen phosphate, and 0.8 mole of ammonium pentaborate, and 1.2 moles of excess ammonia as ammonium hydroxide.

In his patent of Oct. 10, 1989 entitled Insecticidal Compounds (U.S. Pat. No. 4,873,084), Sallay teaches the method of equi-molar amounts, and the necessity of providing enough ammonia to produce ammonium tetraborate. However, Sallay attempts to divert from the established practice of alkaline earth tetraborates and ammonium salts of selected mineral acids in water by procedures stated in Example 2, and in Example 3. However the teachings are flawed, and if a formulator were to exactly follow his directions, the reaction products would be primarily boric acid, and the corresponding sodium salt with less than expected fire retardant performance.

In Example 2 of the Oct. 10, 1989 patent, Sally teaches a method of diluting the concentrated ammonium hydroxide in water, followed by the addition of phosphoric acid, and lastly adding sodium tetraborate. However the recipe of the example is incorrect, wherein the stated amount of concentrated ammonium hydroxide (28%) is far less than required to provide the desired amount of ammonium pentaborate. The example states that 48.6 mls of concentrated ammonium hydroxide is equivalent to 8 moles of ammonia. The stated amount of 48.6 mls of concentrated ammonium hydroxide provides only 0.35 moles of ammonium hydroxide, far insufficient to react with 8 moles of borax and 8 moles of phosphoric acid to provide any quantity of ammonium pentaborate. This concept can be illustrated follows.
NH₃+H₂O→NH₄OH
Thus, with aqueous ammonia (ammonium hydroxide) one mole of ammonium hydroxide contains one mole of ammonia. Thus it requires ammonium hydroxide at 35 grams per mole to obtain one mole of ammonia (17 grams/mole). Therefore with concentrated ammonium hydroxide at 28%, it requires;
(35 grams/mole NH₄OH)/(0.28)=125 grams of aqua ammonia to obtain 17 grams of ammonia. Since the specific gravity of concentrated ammonium hydroxide is 0.9 grams/ml., it requires;

(125 grams)/(0.9 grams/ml)=138.9 mls of 28% ammonium hydroxide to provide one mole of ammonium hydroxide and one mole of ammonia.

In the patent issued on Oct. 10, 1989, Sallay diverts from his usual teachings again as demonstrated by example 3. In this procedure, he again uses the amount of concentrated ammonium hydroxide of 48.6 mls, but in this procedure states it is only 0.8 moles of ammonia. The attempt is to use 0.8 moles of ammonia to produce the 0.8 moles of ammonium pentaborate without excess ammonia present in the aqueous solution. Again the chemistry is in error as 48.6 mls of 28% ammonium hydroxide is only 0.35 moles of ammonium hydroxide.

Sallay, in his succession of patents has taught the art of reacting alkaline earth tetraborates with ammonium sulfite, sulfate, or di-ammonium hydrogen phosphate, and, by using ammonia gas and sulfur dioxide, and, by using methanol or water as the solvent. That technology was promoted because it was believed necessary to provide enough ammonia to produce the interim product of ammonium tetraborate. The transition to ammonium pentaborate then results in the release of ammonia which becomes excess ammonia in the form of ammonium hydroxide.

The excess of ammonia in the quantity so produced in the patents authored by Sally is not beneficial in some applications. In the manufacture of particle board or oriented strand board (OSB) the quantity of excess ammonia as produced in earlier patents interferes with the cross-linking mechanism of resin systems, decreasing bond strengths of the wood composites. Producing aqueous solutions of ammonium pentaborate by methods described herein, have the advantage of containing by choice little or no residual ammonia making the compositions compatible with binding resins used in the manufacture of wood composites.

### BRIEF DESCRIPTION OF THE INVENTION

This invention describes the methods of producing aqueous solutions of ammonium pentaborate with little or no residual ammonia. This is accomplished by reacting an alkaline earth tetraborate in water with acid to produce the alkaline acid salt and boric acid, followed by the addition of the correct amount of ammonia or ammonium hydroxide. By adjusting the ratios of mineral acid and tetraborate, the so generated solutions contain by design, 0.2 moles, or no residual ammonia as compared to 1.2 moles of residual ammonia from earlier patent descriptions.

### DETAILED DESCRIPTION OF THE INVENTION

It has been discovered that by reacting alkaline earth tetraborates in water with selected mineral acids, followed by the addition of ammonia or ammonium hydroxide, the so generated solutions contain by design 0.2 moles of residual ammonia, or no residual ammonia. Reactions to produce aqueous solutions of ammonium pentaborate using ammonium, di-ammonium or acid ammonium salts (as NH₄Cl, (NH₄)₂SO₄ and NH₄HSO₄), are not appropriate as the resultant solutions generate 1.2 moles of residual ammonia. This can best be seen by the following reactions.

A. Ammonium salts
1). Na₂B₄O₇.5H₂O+2NH₄Cl+water→2NaCl+0.8NH₄B₅O₈.4H₂O+1.2NH₄OH
B. di-Ammonium salts
2) Na₂B₄O₇.5H₂O+(NH₄)₂SO₄+water→Na₂SO₄+0.8NH₄B₅O₈.4H₂O+1.2NH₄OH
C. Ammonium acid salts
3) Na₂B₄O₇.5H₂O+2NH₄HSO₄+water→2NaHSO₄+0.8NH₄B₅O₈.4H₂O+1.2NH₄OH

However, utilizing an alkaline earth tetraborate as sodium tetraborate with nitric, hydrochloric acids, sulfurous, sulfuric, and phosphoric acids in water to generate boric acid first, followed by ammonia or ammonium hydroxide are viable methods. By adjusting the ratio of reactants it is possible to generate aqueous solutions of ammonium pentaborate and by design, control the amounts of residual ammonia as ammonium hydroxide. To produce 0.2 moles of residual ammonia;
4) a. Na₂B₄O₇.5H₂O+2HCl+water→2NaCl+4H₃BO₃+water
b. 2NaCl+4H₃BO₃+NH₄OH→0.8NH₄B₅O₈.4H₂O+2NaCl+0.2NH₄OH+water
5) a. Na₂B₄O₇.5H₂O+2HNO₃+water→2NaNO₃+4H₃BO₃+water
b. 2NaNO₃+4H₃BO₃+NH₄OH+water→2NaNO₃+0.8NH₄B₅O₈.4H₂O+0.2NH₄OH
6) a. Na₂B₄O₇.5H₂O+H₂SO₄+water→Na₂SO₄+4H₃BO₃
b. Na₂SO₄+4H₃BO₃+NH₄OH+water→0.8NH₄B₅O₈.4H₂O+Na₂SO₄+0.2NH₄OH
7) a. Na₂B₄O₇.5H₂O+H₂SO₃+water→Na₂SO₃+4H₃BO₃
b. Na₂SO₃+4H₃BO₃+NH₄OH+water→0.8NH₄B₅O₈.4H₂O+Na₂SO₃+0.2NH₄OH
8) a. Na₂B₄O₇.5H₂O+H₃PO₄+water→Na₂HPO₄+4H₃BO₃
b. Na₂HPO₄+4H₃BO₃+NH₄OH+water→0.8NH₄B₅O₈.4H₂O+Na₂HPO₄+0.2NH₄OH
A process to provide one mole of ammonium pentaborate instead of 0.8 mole, can be made by changing the reactant ratios. The ratio adjustments produces exactly one mole of ammonium pentaborate with no residual ammonia as shown by the following reactions;
9) a. 1.25Na₂B₄O₇.5H₂O+2.5HCl→2.5NaCl+5H₃BO₃
b. 2.5NaCl+5H₃BO₃+NH₄OH→(NH₄)B₅O₈.4H₂O+2.5NaCl
10) a. 1.25Na₂B₄O₇.5H₂O+2.5HNO₃→2.5NaNO₃+5H₃BO₃
b. 2.5NaNO₃+5H₃BO₃+NH₄OH→(NH₄)B₅O₈.4H₂O+2.5NaNO₃
11) a. 1.25Na₂B₄O₇.5H₂O+1.25H₂SO₃+water→1.25Na₂SO₃+5H₃BO₃
b. 1.25Na₂SO₃+5H₃BO₃+NH₄OH→1.25Na₂SO₃+NH₄B₅O₈.4H₂O+water
12) a. 1.25Na₂B₄O₇.5H₂O+1.25H₂SO₄+water→1.25Na₂SO₄+5H₃BO₃
b. 1.25Na₂SO₄+5H₃BO₃+NH₄OH→NH₄B₅O₈.4H₂O+1.25Na₂SO₄+water
13) a. 1.25Na₂B₅O₇.5H₂O+1.25H₃PO₄+water→1.25Na₂HPO₄+5H₃BO₃
b. 1.25Na₂HPO₄+5H₃BO₃+NH₄OH→1.25Na₂HPO₄+NH₄B₅O₈.4H₂O+water
Note that in reactions numbered 4-8, there is an excess amount of ammonia as ammonium hydroxide of 0.20 moles, but in the adjustment made in reactions 8-13, above, there is no excess ammonia. However, in using hydrochloric, and or nitric acid, the alkaline earth salts are generally corrosive to metal, and cannot be used for the treatment of wood and wood composites that come in contact with most metal fasteners.

Nowhere in any relevant patent have these methods of producing aqueous ammonium pentaborate solutions designed to specifically control the amount of excess ammonium hydroxide generated been taught. The benefit of these methods are to produce an aqueous solution of ammonium pentaborate with the corresponding sodium salt and a very slight excess of ammonia, or no excess ammonia. These methods produce aqueous ammonium pentaborate solutions that are compatible with resins utilized in the manufacture of wood composites. The inventive methods then provides the formulator the flexibility of preparing an aqueous solution of ammonium pentaborate with controlling the amount of residual ammonia of 0.20 moles, or zero moles, compared to 1.2 moles of ammonia by methods previously taught.

The art taught by Sallay suggests that di-ammonium salts are required to produce ammonium tetraborate with the subsequent release of ammonia in the conversion to ammonium pentaborate. The method taught by Sallay produces ammonium hydroxide in quantities six times greater than the inventive method. In the inventive methods, ammonium salts are not used and therefore, ammonium tetraborate can not be generated, In the disclosed methods, boric acid is generated first, and ammonium pentaborate is then produced directly from the addition of ammonia, or ammonium hydroxide. The correct amount of ammonia must be provided to convert all of the generated boric acid ultimately to ammonium pentaborate.

It is to be stated that when using the selected mineral acid and ammonium hydroxide, the sequence of reactants is important and can affect the resultant products. Sodium tetraborate when added to cold water, coalesces into a hard packed solid which takes considerable heat and stirring to reverse. The action of adding concentrated sulfuric acid to aqua ammonia results in violent reactions resulting in flashing off of ammonia as a vapor, reducing the efficiency of the reaction and the quantity of ammonium pentaborate generated. The suggested procedure is to first add the sulfuric acid (or mineral acid) to the water. An exotherm is created by simply adding the sulfuric acid to the water. The resulting exotherm will raise the acidic solution to a temperature where the addition of the borax will not result in the borax coalescing, but immediately reacts with the sulfuric acid and produces both boric acid and sodium sulfate. The naturally provided exotherm also aids in requiring less external heat needed to attain the temperature required to prevent the borax from coalescing and to quickly react with the acid. With the sulfuric acid neutralized and used, anhydrous ammonia can now be easily added beneath the liquid surface by a sparging tube, or concentrated ammonium hydroxide can be easily added without the reaction violence and exotherm resulting in increased efficiency in the reaction process.

### EXAMPLE 1

a. Na₂B₄O₇.5H₂O+H₂SO₄+water→Na₂SO₄+4H₃BO₃+water
b. Na₂SO₄+4H₃BO₃+NH₄OH→0.8NH₄B₅O₈.4H₂O+Na₂SO₄+0.2NH₄OH

To a 4 liter beaker placed on a combination hot/plate stirrer, 2.5 liters of warm (28.5° C.) tap water is added. Stirring is initiated, and to the water is added 57.3 (57.27) mls of 93% sulfuric acid, raising the water temperature to 34.4° C. To the acid//water solution, is added 291.35 grams of 5-mole borax. Under stirring and increased heat, the solution is initially hazy, and opaque, but quickly becomes clear. 139 mls of 28% ammonium hydroxide is added while stirring. The reaction between the ammonium hydroxide and the acidic water and dissolved borax is mild. The temperature rises from 53.2° C. to 58.5° C. with the addition of the ammonium hydroxide. The solution becomes completely clear and transparent. Tap water is added to dilute to the final volume to 3.785 liters. The temperature is 53° C., and the pH is found to be 8.4

### EXAMPLE 2

a. 1.25Na₂B₄O₇.5H₂O+1.25H₂SO₄+water→1.25Na₂SO₄+5H₃BO₃
b. 1.25Na₂SO₄+5H₃BO₃+NH₄OH+water→1.0NH₄B₅O₈.4H₂O+1.25Na₂SO₄

Place 2.5 liters of tap water in a 4 liter pyrex beaker. Place beaker and contents on a combination hot plate/stirrer. Stirring was initiated and 71.6 mls of 93% sulfuric acid. was added to the water. Initial water temperature was 26.5° C. but rose to 38.6° C. due to the generated exotherm. To the warm solution is added, with increased stir speed, 364.2 grams of 5-mole borax. Mixture volume near 2.750 liters. Mixture is initially cloudy and opaque. The heat plate is turned on to heat the mixture to aid in dissolving the borax. The solution is completely clear and transparent at 53° C. Hot plate is turned off, and with continual stirring, to the solution is added 139 mls of 28% ammonium hydroxide. The reaction between the ammonium hydroxide is very mild, and the solution temperature rose to 60.5° C. The hot solution is crystal clear. Cold tap water is added to dilute the solution to 3.785 liters. Final pH is 8.10.

### EXAMPLE 3

a. 1.25Na₂B₄O₇. 5H₂O+2.5HCl→5H₃BO₃+2.5NaCl
b. 2.5NaCl+5H₃BO₃+NH₄OH→NH₄B₅O₈.4H₂O+2.5NaCl

Place 2.5 liters of tap water into a 4 liter pyrex beaker. Place the beaker and contents on a combination stirrer hot plate and initiate gentle stirring. Cautiously add 207 mls of con HCl. The temperature of the tap water rises from 22° C., to 24° C. The pH measures 0.38 The acid water solution was heated to near 60° C. to avoid the borax from coalescing before it could be dissolved. 364.18 grams of 5-mole borax. was added and the stir speed was slightly increased as the borax was added. The mixture remained cloudy for a few moments, and then became completely clear and transparent. The temperature was found to be 56.3° C. and the pH at this stage measured 4.90. To the solution was cautiously added 138 mls of 28-29% ammonium hydroxide. No exotherm or reaction violence took place. The addition of the ammonium hydroxide was very mild. The solution remained clear and transparent, but has a very slight pale yellow tint. Solution volume has increased to 2800 mls from the original 2500 mls. Tap water was added to bring the final volume to 3800 mls. Final temperature is 53.6° C., and pH is 9.00

### EXAMPLE 4

The inventive solutions can be prepared with high solids content. A solution was prepared as in Example 2 at 50% solids based on weight per volume. The solution was still clear and transparent at a temperature of 95° F. The solution was prepared by placing 500 mls of tap water in a 2 L beaker. A volume of 73 mls of 93% sulfuric was added to the water with mixing. The addition of the acid produced an exotherm, changing the temperature from 22° C. to 65° C. Sodium tetraborate, 5-mole in the amount of 364.2 grams was added under mixing. The resultant mixture was a thick white, granular slurry. Ammonium hydroxide (28%), was added in the amount of 138 mls. Immediately upon the addition of the ammonium hydroxide, the granular solids began to go onto solution. At the end of the addition of the ammonium hydroxide, the solution was very slightly hazy, and within a few moments, became completely clear and transparent. Final volume was 900 mls. The temperature was 64° C. and the pH measured 7.9. The solution was allowed to stand and cool. No precipitation had occurred at 37° C. Final solution pH was found to be 7.9.

Successful use of this newly formulated aqueous based system of ammonium pentaborate containing a very slight excess or no excess ammonia as ammonium hydroxide has been established in the manufacture of particle board and oriented strand board (OSB). Wood composites have been manufactured using the inventive solution with the use of urea-formaldehyde (UF) resin, methylene di-isocyanate resin, liquid phenol, and melamine resin. Wood chips and strands have been treated with the so produced solution by the use of a spinning disc atomizer and a rotating drum. The treated strands and/or chips have then been combined with resin and wax and, under heat and pressure, have been formed into wood composites.

### EXAMPLE 5

Mixed hardwood strands were treated with the inventive solution prepared as in example 2. The hardwood strands were treated by using a spinning disc atomizer as the strands were exposed to the solution contained in a rotating drum. The treated strands were then treated with melamine resin and wax. The strands were removed from the rotating drum, and formed into a mat, which was then subjected to a heated press to form the strand board. The formed oriented strand board was cooled trimmed and cut in to rectangles, 2.0 inches by 1.0 inch. The so prepared OSB was then used in a study to determine resistance to attack by Formosan Termites. Chemical analysis of the strand board revealed a boric acid content equivalent of 5.75%. A “No Choice” test was conducted with Formosan termites using the treated strand board along with similarly manufactured southern yellow pine strand board that was untreated, and southern yellow pine blocks as a control. After 4 weeks of exposure to Formosan termites, the treated oriented strand board (OSB) successfully resisted attack, sustaining only minor nibbles. The untreated southern yellow pine OSB and the control blocks of southern yellow pine were severely attacked by the Formosan termites. Oriented strand board utilizing melamine resin and the inventive ammonium pentaborate solution also shows flame and fire retardation properties imparted by the solution.

### EXAMPLE 6

Particle board manufactured using the inventive solution as in Example 4 was made utilizing wood chips and a spinning disc atomizer and rotating drum and urea-formaldehyde resin. The so constructed board was analyzed for boric acid equivalent, was found was to contain 6.34% BAE. The material so made was subjected to fire resistant testing using a 25 foot tunnel with a burn duration of 30 minutes. The tests conducted at Omega Point Laboratory resulted in a flame spread rating (FSR), of 0 and a smoke index of 0.

### EXAMPLE 7

Treated wood and wood composites are likely to come into contact with a variety of metal fasteners, hinges and other fastening or cosmetic devices. A study was conducted using solution as prepared in accordance with Example 2, in the manufacture of particle board to determine the corrosive characteristic of wood and wood composites treated with the inventive solution. For this study, the protocol followed was the American Wood Preservers' Association (AWPA) Test Standard E12-94 entitled Standard Method of Determining Corrosion of Metals in Contact with Treated Wood. This study requires that metal strips made of aluminum, brass, steel, and zinc galvanized steel are sandwiched in between samples of the treated wood, or wood composite. The sample assemblies are then exposed to conditions of 120° F. and 90% relative humidity for a period of 10 days (240 hours). The weights of the metal strips are measured before and after the ten-day period, with weight loss being associated with weight loss due to corrosion. After the ten-day period, the samples were disassembled and the test strips weighed to determine the weight loss due to corrosion. None of the metal test strips show any weight loss, an indication that the particle board treated with the inventive solution is non-corrosive according to AWPA Standard E12-94.

### EXAMPLE 8

Solution as prepared as in Example 2 was utilized in the pressure treating of plywood. Plywood samples at one foot square, were prepared from ½″×4′×8′ sheets of plywood made of southern yellow pine. The plywood exhibited one surface free of voids and surface knots. The other surface was free of voids but contained surface knots. Three treating solutions at different levels of % BAE were prepared for pressure treating the plywood samples. Four plywood samples were treated by each of the three treatment solutions. By design, the three levels of solution were at nominal strengths of 3%, 5% and 7% BAE. All plywood samples were treated simultaneously to ensure continuity of the treatment procedure for all samples. The plywood samples were completely submerged during the treatment cycle. A vacuum of 22 in. Hg. Was applied, followed by 125 psi of pressure. After the treatment cycle, the plywood samples were drained, wiped, and placed in a convection drying oven at 50° C. for four consecutive days. The samples were then and conditioned at ambient conditions prior to being subjected to burn tests to evaluate the fire retardant properties of the treated samples.

### EXAMPLE 9

Hardwood strands were treated with the solution as prepared in Example 2 by a spinning disc atomizer in a rotating drum. The solution strength was provided to result in a % BAE level of 7.5% BAE in the finished board. The strands were removed and dried to a moisture content of 3%. The strands were treated with a blend of resins, specifically a blend of (ISO/UF) and (PMUF) and then made into oriented strand board. Physical structural tests resulted in board properties superior to the control panels that were manufactured with untreated chips, but utilized the same resin blend.

A slight excess of ammonium hydroxide has some beneficial properties. Ammonium hydroxide aids in helping dissolved solids remain in solution. Solution concentrations of up to 70% solids (weight/volume) have been produced. Although, upon cooling, some of the reaction products will precipitate at room temperature, all precipitated solids will re-dissolve with heating and stirring.

It has been found that a slight excess of ammonium hydroxide performs similarly to a surfactant, helping the solution and dissolved solids penetrate into wood during treatment involving spraying, dipping, diffusion, and pressure treatment.

The inventive methods not only allows the use of the so produced aqueous solutions for the treatment of wood and wood composites, but also other cellulose based materials such as fiberboard, paper, and fabrics.

Yet another advantage of the inventive methods is that the solids generated in aqueous solutions can be recovered by removing the water by evaporation or through spray drying by atomization of the solutions. These solids so generated can be used in the addition to wood chips, particles and strands in the manufacture of wood composites.

I claim:

1. A method of producing ammonium pentaborate in an aqueous solution containing 0.20 moles of residual ammonia as ammonium hydroxide, by reacting 1.0 mole of an alkaline earth tetraborate with, 2.0 moles of either hydrochloric or nitric acid in water, followed by 1.0 mole of ammonia or ammonium hydroxide.

2. Where by the method of claim 1 the alkaline earth tetraborate is selected from a list, but not limited to, Tincal (5 or 10 mole borax), Rasorite, Kernite, and and industrially produced anhydrous borax.

3. Where by the method of claim 1 the composition of matter comprises 0.8 mole ammonium pentaborate, 2.0 mole of the alkaline earth chloride or nitrate, and 0.20 mole of residual ammonia as ammonium hydroxide in water.

4. A method of producing ammonium pentaborate in an aqueous solution containing 0.20 moles of residual ammonia as ammonium hydroxide, by reacting 1.0 mole of an alkaline earth tetraborate with, 1.0 mole of sulfuric, sulfurous, or phosphoric acid in water, followed by 1.0 mole of ammonia or ammonium hydroxide.

5. Where, by the method of claim 4, the alkaline earth tetraborate is selected from a list of, but not limited to, Tincal (5 or 10 mole borax), Rasorite, Kernite, and industrially produced anhydrous borax.

6. Where, by the method of claim 4, the composition of matter comprises 0.8 mole ammonium pentaborate, 1.0 mole of the alkaline earth sulfate, sulfite, and acid-hydrogen phosphate, and 0.20 mole of residual ammonia as ammonium hydroxide in water.

7. A method of producing ammonium pentaborate in an aqueous solution containing no residual ammonia, by reacting 1.25 mole of an alkaline earth tetraborate with, 1.25 mole of sulfuric, sulfurous, or phosphoric acid in water, followed by 1.0 mole ammonia or ammonium hydroxide.

8. Where, by the method of claim 7, the alkaline earth tetraborate is selected from a list of, but not limited to, Tincal (5 or 10 mole borax), Rasorite, Kernite and industrially produced anhydrous borax.

9. Where, by the method of claim 7, the composition of matter comprises 1.0 mole ammonium pentaborate, 1.25 mole of the alkaline earth sulfite, sulfate, and acid-hydrogen phosphate in water.

10. A method of producing ammonium pentaborate in an aqueous solution containing no residual ammonia, by reacting 1.25 moles of an alkaline earth tetraborate with, 2.5 moles of hydrochloric or nitric acid in water, followed by 1.0 mole of ammonia or ammonium hydroxide.

11. Where by the method of claim 10, the alkaline earth tetraborate is selected from a list of, but not limited to, Tincal (5 or 10 mole borax), Rasorite, Kernite, and industrially produced anhydrous borax.

12. Where, by the method of claim 10, the composition of matter comprises 1.0 mole ammonium pentaborate, and 2.5 moles of the alkaline earth chloride or nitrate in water.

13. Where the compositions of matter of claims 3, 6, 9, and 12 can be used to treat wood and wood products, and also wood chips, particles, strands and wood laminates used in wood composites by spraying, dipping, diffusion and pressure treating.

14. The compositions of matter claim 13 impart to the treated wood and wood products, and to the treated wood particles, chips strands and wood laminates, the properties of flame retardancy, and resistance to attack by wood eating/destroying insects.

15. The compositions of matter of claim 13 are compatible with binding resins used in the manufacture of particle board, chip and/or strand board, and wood laminates such as plywood.

16. Where the binding resin of claim 15 is selected from a list comprised of, but not limited to, urea-formaldehyde (UF), methylene di-isocyanate (MDI), phenol, melamine, isocyanate (ISO), and mixtures thereof.

17. The compositions of matter of claims 3, 6, 9, and 12 may be recovered as solids by removing the water by evaporation and/or spray drying and used for the treatment of wood composites such as particle board, chip and strand board.

18. The recovered solids of claim 17 are compatible with the binding resins of claim 16.

19. The compositions of matter of claim 17 impart to the treated wood composites the properties of fire retardancy and resistance to attack by wood eating/destroying insects.
